(19) United States
(12) Patent Application Publication
(10) Pub. No.: US 2024/0284376 A1
(43) Pub. Date: Aug. 22, 2024

(54) Method And Apparatus For Synchronization And Radio Resource Management In Mobile Communications

(71) Applicant: MediaTek Inc., Hsinchu City (TW)

(72) Inventors: Chien-Chun Cheng, Hsinchu City (TW); Wei-De Wu, Hsinchu City (TW); Yi-Ju Liao, Hsinchu City (TW); Din-Hwa Huang, Hsinchu City (TW); Yi-Chia Lo, Hsinchu City (TW)

(21) Appl. No.: 18/379,642

(22) Filed: Oct. 12, 2023

Related U.S. Application Data
(60) Provisional application No. 63/485,550, filed on Feb. 17, 2023.

(51) Int. Cl. H04W 56/00; H04W 52/02

(52) U.S. Cl. CPC H04W 56/0075; H04W 52/0229

(57) ABSTRACT

Examples pertaining to synchronization and radio resource management in mobile communications are described. A user equipment (UE) receives a periodic low power synchronization signal (LP-SS) from a network node via a low-power wake-up receiver (LP-WUR) of the apparatus. Then, the UE performs a synchronization based on the periodic LP-SS via the LP-WUR of the apparatus in an event that a main radio of the apparatus is in a power saving mode. The synchronization comprises at least a coarse time synchronization and a coarse frequency synchronization.

### CROSS REFERENCE TO RELATED PATENT APPLICATION(S)

The present disclosure is part of a non-provisional application claiming the priority benefit of U.S. Patent Application No. 63/485,550, filed 17 Feb. 2023, the content of which herein being incorporated by reference in its entirety.

### TECHNICAL FIELD

The present disclosure is generally related to mobile communications and, more particularly, to using a low power wake up receiver to receive a periodic low power synchronization signal for synchronization and to radio resource management with respect to user equipment and network apparatus in mobile communications.

### BACKGROUND

Unless otherwise indicated herein, approaches described in this section are not prior art to the claims listed below and are not admitted as prior art by inclusion in this section.

The fifth-generation (5G) network, despite its enhanced energy efficiency in bits per Joule (e.g., 417% more efficiency than a 4G network) due to its larger bandwidth and better spatial multiplexing capabilities, may consume over 140% more energy than a 4G network.

Therefore, it is important to achieve 5G network power savings. There are many conflicts among performance metrics. Quality of service (QOS) and power savings may need a tradeoff. Some local optimal solutions may not achieve the global/overall optimum. For example, the wake-up signal (WUS) saving user equipment power by 20% may degrade 30% of base station power savings. However, it would be beneficial to get more BS sleep time for 5G network power savings.

Accordingly, how to achieve network power saving becomes an important issue for the newly developed wireless communication network. Therefore, there is a need to provide proper schemes for network power saving.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to network power saving with respect to user equipment (UE) and network apparatus (e.g., a network node or a base station (BS), such as a next generation Node B (gNB)) in mobile communications.

In one aspect, a method may involve an apparatus performing coarse synchronization with a network node. The method may also involve the apparatus receiving a periodic Low Power Synchronization Signal (LP-SS) from the network node via a low-power wake-up receiver (LP-WUR) of the apparatus and performing a synchronization based on the periodic LP-SS via the LP-WUR of the apparatus in an event that a main radio of the apparatus is in a power saving mode. The synchronization may comprise at least a coarse time synchronization and a coarse frequency synchronization.

In one aspect, an apparatus may involve a transceiver which, during operation, wirelessly communicates with at least one network node. The transceiver may comprise a main radio and a low-power wake-up receiver (LP-WUR). The apparatus may also involve a processor communicatively coupled to the transceiver such that, during operation, the processor performs following operations: receiving, via the LP-WUR, a periodic Low Power Synchronization Signal (LP-SS) from the network node; and performing, via the LP-WUR, a synchronization based on the periodic LP-SS in an event that the main radio is in a power saving mode. The synchronization may comprise at least a coarse time synchronization and a coarse frequency synchronization.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of main radio switching under schemes in accordance with implementations of the present disclosure.

FIG. 2 is a diagram depicting an example scenario of LP-WUR architecture with corresponding signal processing under schemes in accordance with implementations of the present disclosure.

FIG. 3 is a diagram depicting an example scenario of LP-WUR packet structure under schemes in accordance with implementations of the present disclosure.

FIG. 4 is a diagram depicting an example scenario of signal processing at gNB TX under schemes in accordance with implementations of the present disclosure.

FIG. 5 is a diagram depicting an example scenario of packet detection under schemes in accordance with implementations of the present disclosure.

FIG. 6 is a diagram depicting an example scenario of OOK demodulation under schemes in accordance with implementations of the present disclosure.

FIG. 7 is a diagram depicting an example scenario of miss detection rate (MDR)/false alarm rate (FAR) determination under schemes in accordance with implementations of the present disclosure.

FIG. 8 is a diagram depicting an example scenario of operations of MR

and LP-WUR in a transceiver under schemes in accordance with implementations of the present disclosure.

FIG. 9 is a diagram depicting an example scenario of LP-WUR architecture with corresponding signal processing under schemes in accordance with alternative implementations of the present disclosure.

FIG. 10 is a diagram depicting an example scenario of operations of MR and LP-WUR in a transceiver under schemes in accordance with alternative implementations of the present disclosure.

FIG. 11 is a diagram depicting an example scenario of LP-WUR activation/initialization procedure under schemes in accordance with implementations of the present disclosure.

FIG. 12 is a diagram depicting an example scenario of LP-WUS

reception ensuring procedure under schemes in accordance with implementations of the present disclosure.

FIG. 13 is a diagram depicting an example scenario of skipping PDCCH monitoring in SCell in FR2 under schemes in accordance with implementations of the present disclosure.

FIG. 14 is a diagram depicting an example scenario of skipping or relaxing RRM measurement determination procedure under schemes in accordance with implementations of the present disclosure.

FIG. 15 is a diagram depicting an example scenario of LP-WUS RSRP threshold determination procedure under schemes in accordance with implementations of the present disclosure.

FIG. 16 is a diagram depicting an example scenario of CP pattern determination procedure under schemes in accordance with implementations of the present disclosure.

FIG. 17 is a diagram depicting an example scenario of skipping LP-WUS determination procedure under schemes in accordance with implementations of the present disclosure.

FIG. 18 is a diagram depicting an example scenario of LP-WUS segments combining procedure under schemes in accordance with implementations of the present disclosure.

FIG. 19 is a block diagram of an example communication system in accordance with an implementation of the present disclosure.

FIG. 20 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to synchronization and radio resource management for network energy saving. According to the present disclosure, a number of possible solutions may be implemented separately or jointly. That is, although these possible solutions may be described below separately, two or more of these possible solutions may be implemented in one combination or another.

The present disclosure proposes several schemes pertaining to network power saving (or network energy saving) with respect to UE and network apparatus in mobile communications.

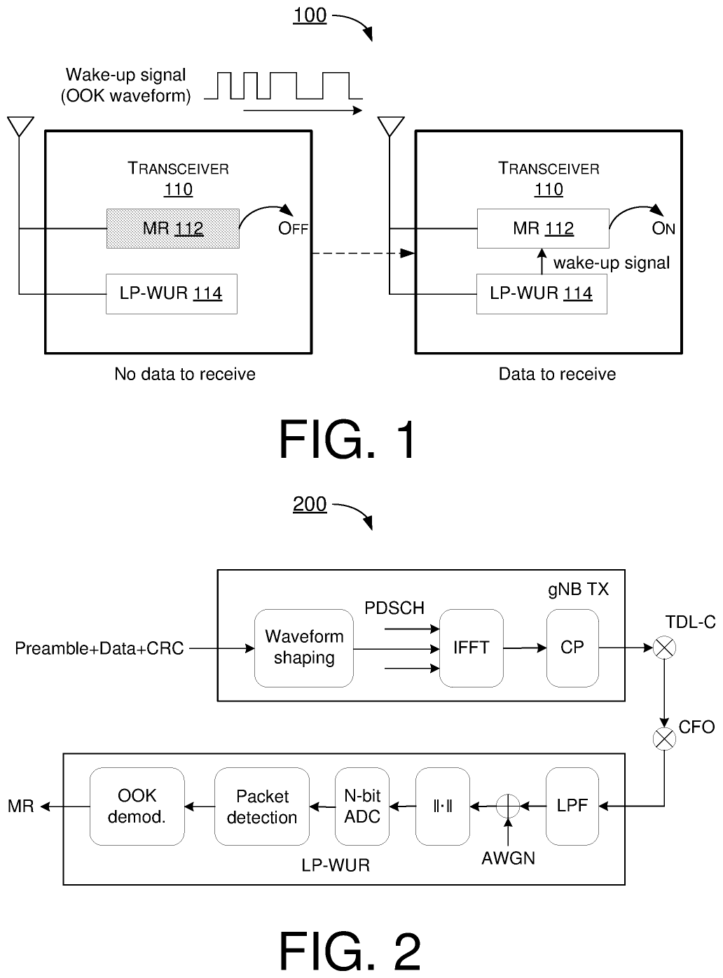

FIG. 1 illustrates an example scenario 100 of main radio switching of a transceiver of a communication apparatus under schemes in accordance with implementations of the present disclosure. Transceiver 110 of a communication apparatus may include a main radio (MR) 112 and a low power wake up receiver (LP-WUR) 114. MR 112 is used for user data transmission and reception. In some implementations, MR 112 may operate with the following properties: 1) being turned off unless there is something to transmit; 2) waken up by the LP-WUR 114 when there is a packet to receive; 3) transmitting and/or receiving user data when being turned on.

In some implementations, LP-WUR 114 may not be used for user data and may serve as a simple “wake-up” receiver with the following properties: 1) being a simple receiver (doesn't have a transmitter); 2) being active while MR 112 is turned off; 3) having low power consumption, e.g., <1 milliWatt (mW) in the active state; 4) using simple modulation scheme, e.g., On-Off-Keying (OOK); 5) operating with a narrow bandwidth, e.g., <5 Mega Hertz (MHz).

FIG. 2 illustrates an example scenario 200 of LP-WUR architecture with corresponding signal processing under schemes in accordance with implementations of the present disclosure. LP-WUR may include at least the following circuits or modules: low pass filter (LPF), envelope detector (ED), N-bits analog to digital convertor (ADC), packet detection, and OOK demodulation.

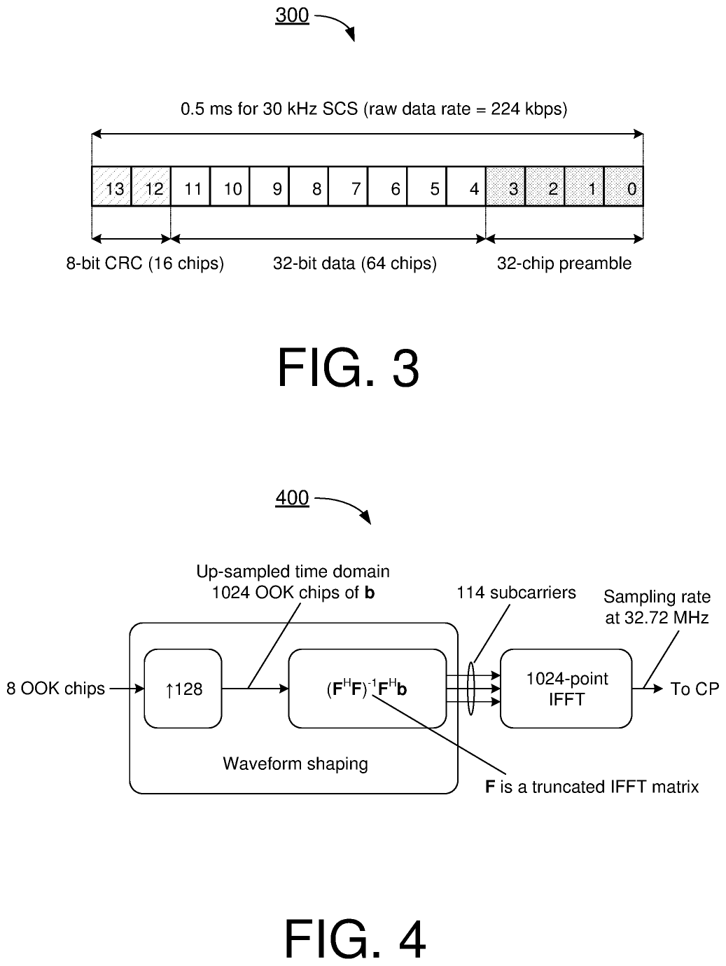

FIG. 3 illustrates an example scenario 300 of LP-WUR packet structure under schemes in accordance with implementations of the present disclosure. In some implementations, the LP-WUR packet structure may include a 32-bit preamble that carries no information but for synchronization, a 64-bit data payload that carries 32 information bits encoded by Manchester coding, a 16-bit CRC that carries 8 information bits encoded by Manchester coding.

FIG. 4 illustrates an example scenario 400 of signal processing at gNB TX as shown in FIG. 2 under schemes in accordance with implementations of the present disclosure. The waveform shaping considers least square (LS) approximation by a truncated IFFT matrix. It up-samples low power wake-up signal (LP-WUS) and passes linear processing. Its output will be allocated to sub-carriers around the DC, i.e., the center frequency.

Referring back to FIG. 2, the low pass filter (LPF) considers a 5th-order Butterworth LPF with a 3 dB cut-off frequency at 2.16 MHz and a sampling rate at 32.72 Mhz. No IQ branch by default, only the real part of the received waveform passes the LPF.

The envelope detector (ED) takes absolute values from the output of the LPF. Note that the ED may be arranged after the N-bit Analog-to-Digital Converter (ADC) if AGC and time and frequency tracking are considered. The proper pre-processing of ED is beneficial.

The N-bit (e.g., 4-bit) ADC considers a sampling rate of 3.84 MHz and a quantization range from 0 to 2. Note that the ADC dynamic range is quite ideal assuming auto gain control (AGC) exists.

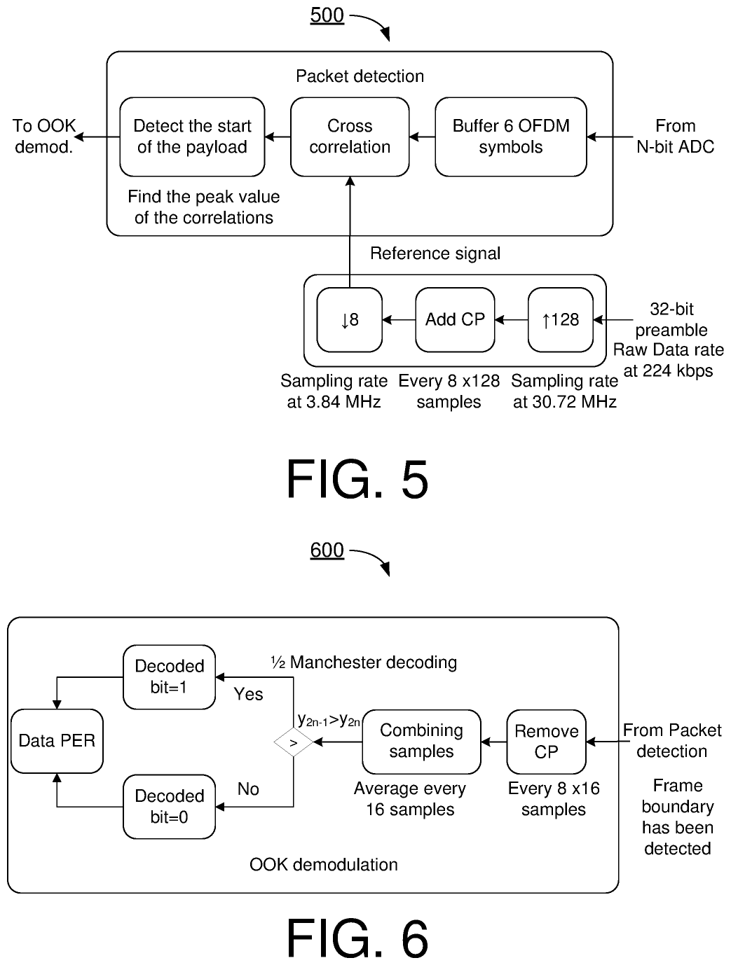

FIG. 5 illustrates an example scenario 500 of packet detection under schemes in accordance with implementations of the present disclosure. The packet detection considers finding the coarse timing. The quantized signal is buffered and cross-correlates with the known preamble sequence. The preamble may need to consider CP impact if more than one OOK is within an orthogonal frequency-division multiplexing (OFDM) symbol. The peak value from the cross-correlation will be used as a start timing of the received LP-WUS packet.

FIG. 6 illustrates an example scenario 600 of OOK demodulation under schemes in accordance with implementations of the present disclosure. The OOK demodulation considers CP removal, combining samples, and Manchester decoding. LP-WUR decodes the data payload after the frame boundary has been detected by the packet detection procedure. Given the OOK duration and the frame boundary, LP-WUR may combine samples into OOK chips (uncoded bits) and decode the chips back to information bits by ½ Manchester decoding, e.g., comparing two consecutive signal amplitudes.

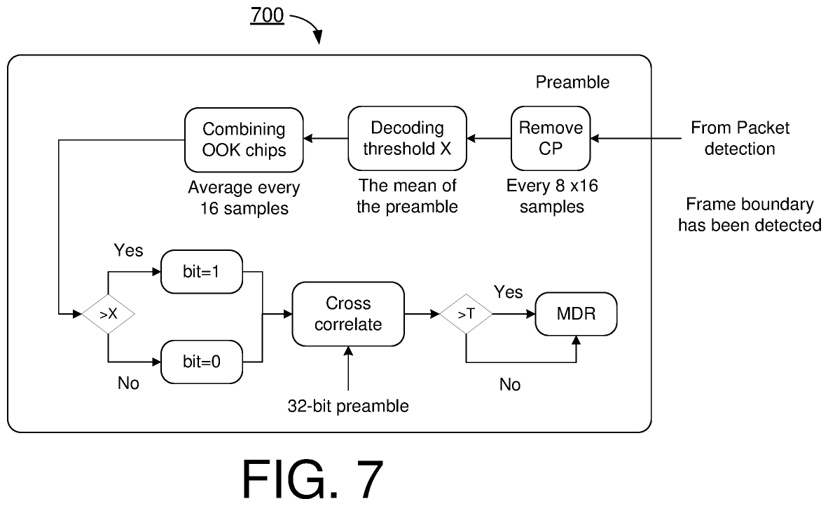

FIG. 7 illustrates an example scenario 700 of miss detection rate (MDR)/false alarm rate (FAR) determination under schemes in accordance with implementations of the present disclosure. The MDR and FAR of preamble detection are determined by a similar process, where the MDR may be determined by a condition if the peak of the correlation is smaller than the threshold T when the preamble is transmitted and the FAR may be determined by a condition if the peak is greater than the threshold T when no preamble is sent. After the frame boundary has been detected, LP-WUR decodes the received preamble into bits by comparing it with the decoding threshold X determined by the mean value of the received preamble. Once the decoded 32-bit preamble has been generated, LP-WUR cross-correlates it with the transmitted 32-bit preamble. The peak of the correlation result is compared with the threshold T to determine MDR and FAR values.

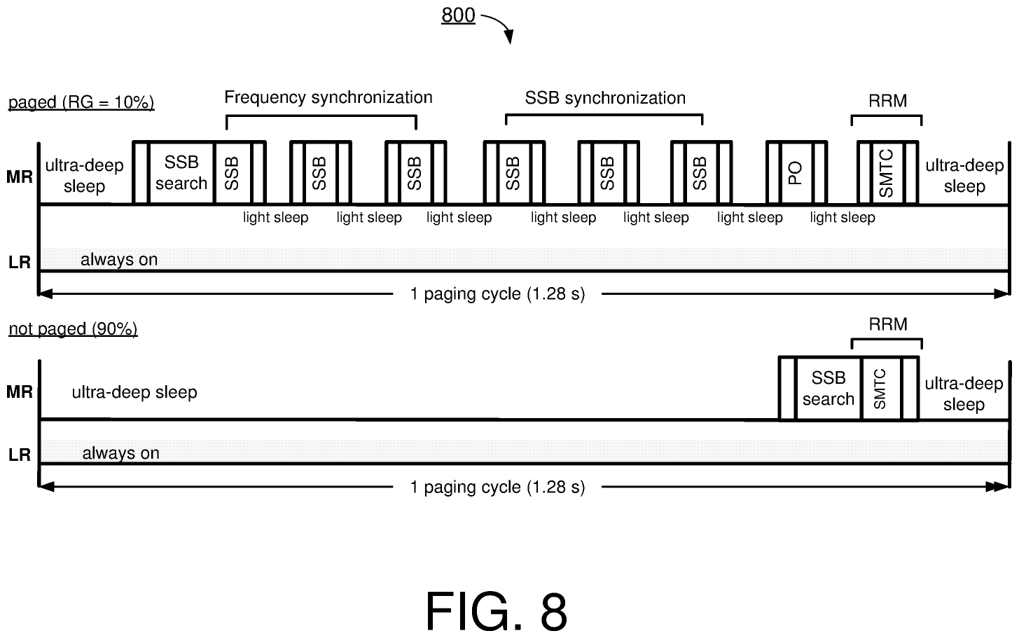

FIG. 8 illustrates an example scenario 800 of operations of a main radio (MR) and a low power wake up receiver (LP-WUR) in a transceiver under schemes in accordance with implementations of the present disclosure. In some implementations, LP-WUR (LR) is always on to monitor LP-WUS. If LR decodes LP-WUS, LR sends a wake-up indication to MR internally to initial re-synchronization and monitor physical downlink control channel (PDCCH) occasions.

In some implementations, another alternative is OFDM-based LP-WUR. An OFDM-based LP-WUR may reuse the existing Primary Synchronization Signal (PSS) to achieve coarse timing and frequency correction, which makes coherent detection possible for a Secondary Synchronization Signal (SSS)-like LP-WUS.

In some implementations, LP-WUR may receive a periodic Low Power Synchronization Signal (LP-SS) from the network node. The processor of the communication apparatus may perform a synchronization via the LP-WUR (e.g., by the digital baseband (BB) processing) based on the periodic LP-SS in an event that the main radio is in a power saving mode. The synchronization may comprise at least a coarse time synchronization and a coarse frequency synchronization.

In some implementations, the periodic LP-SS may comprise at least one of a primary synchronization signal (PSS) and a secondary synchronization signal (SSS).

In some implementations, the processor and/or the digital BB processing of the LP-WUR may estimate a frequency offset based on the periodic LP-SS and perform the coarse frequency synchronization based on the estimated frequency offset.

In some implementations, the processor and/or the digital BB processing of the LP-WUR may estimate a timing offset based on the periodic LP-SS and perform the coarse time synchronization based on the estimated timing offset.

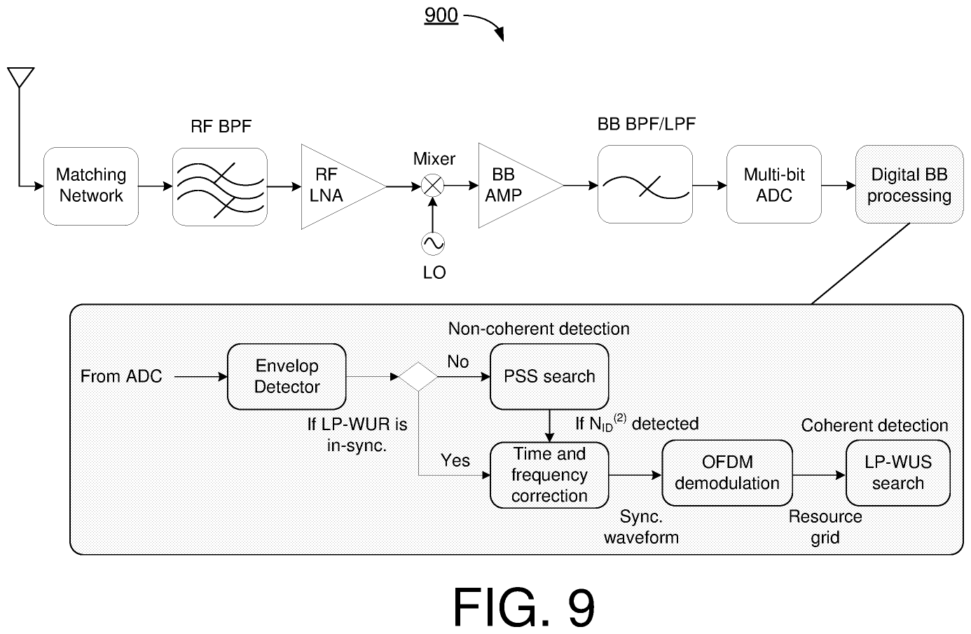

FIG. 9 illustrates an example scenario 900 of LP-WUR architecture with corresponding signal processing under schemes in accordance with alternative implementations of the present disclosure. In some implementations, LP-WUR may frequency shift the received waveform with a candidate frequency offset and correlate the frequency-shifted received waveform with each of the three possible PSS sequences, i.e., N_{ID}⁽²⁾=0, 1, 2, and extract the strongest correlation peak to estimate frequency offsets. Next, LP-WUR may estimate the timing offset to the strongest SS block by using the reference PSS sequence detected in the frequency search process. After frequency offset correction, the LP-WUR may OFDM demodulate the synchronized waveform and extract the resource grid. Finally, LP-WUR may extract the resource elements (REs) associated with the LP-WUS from the received grid and correlate them with each possible LP-WUS sequence generated locally based on the UE group ID or UE ID for LP-WUS search.

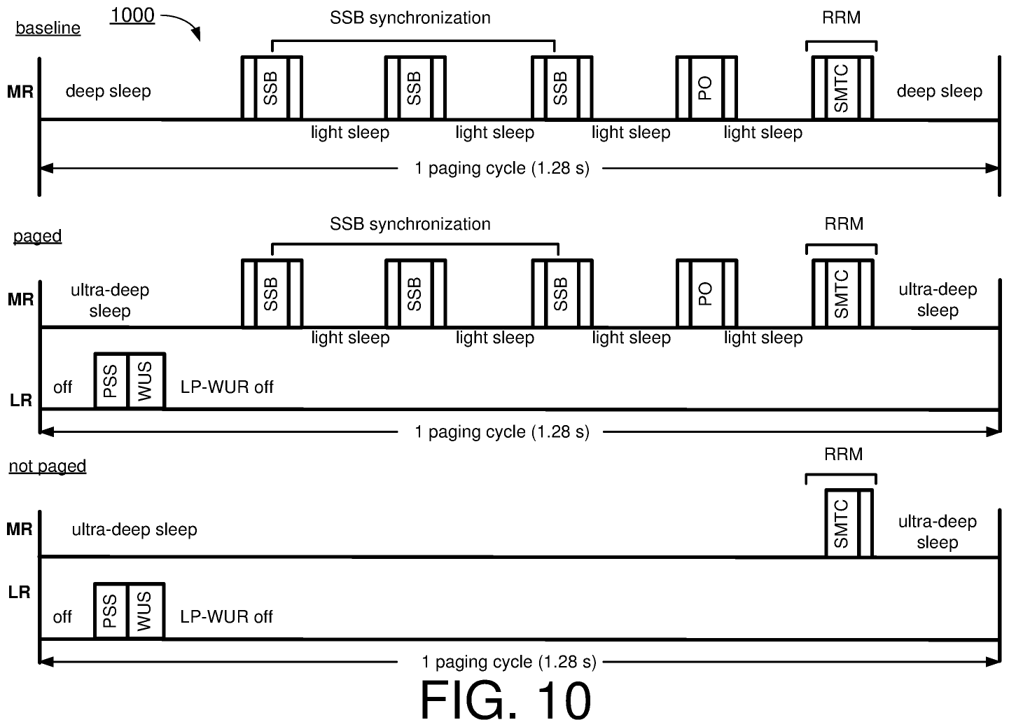

FIG. 10 illustrates an example scenario 1000 of operations of MR and LP-WUR in a transceiver under schemes in accordance with alternative implementations of the present disclosure. The processor of communication apparatus may receive a duty cycle for OFDM-based LP-WUR via radio resource control (RRC) from MR. OFDM-based LP-WUR may monitor PSS and LP-WUS within the same slot based on the duty cycle.

In some implementations, NR signal may be reused and LP-WUR may search NR PSS for timing synchronization. Communication apparatus may receive a reference sequence via RRC by MR based on the broadcast PSS in the serving cell. The reference sequence is used for LP-WUR to search a low-resolution PSS by an envelope detector. LP-WUR uses the timing synchronization based on the NR PSS to monitor LP-WUS.

Regarding how to reuse NR signal, in some implementations, the processor of communication apparatus may report whether LP-WUR supports search of NR PSS via RRC. The processor may report SSB reference signal received power (SSB-RSRP) based on LP-WUR via RRC. LP-WUR may assume LP-WUS has a given offset to PSS. The offset may be configurable by RRC.

Regarding how to activate/initiate LP-WUR, the processor may receive a message from the network node via an RRC signaling via the MR in an RRC connected mode. The message may be a capability enquiry message, a request message to request to turn off the MR or a request message to request to enable the LP-WUR to assist an activation/initialization of monitoring a LP-WUS via the LP-WUR. The processor may further receive a LP-WUS configuration from the network node and determine whether to activate/initiate the monitoring of the LP-WUS according to the message and the LP-WUS configuration.

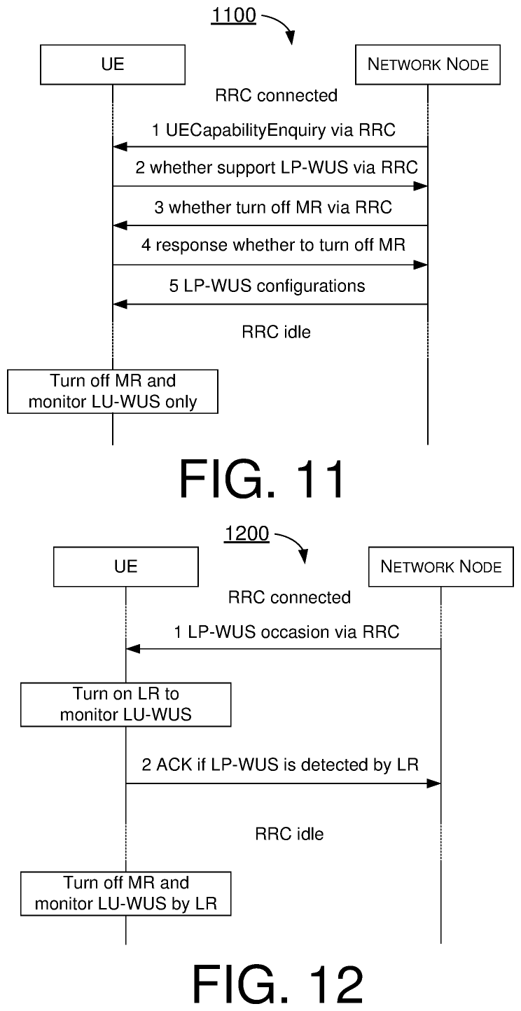

FIG. 11 illustrates an example scenario 1100 of LP-WUR activation/initialization procedure under schemes in accordance with implementations of the present disclosure. In some implementations, the processor of communication apparatus may report whether to support LP-WUS to network node via RRC messages in an RRC connected mode. If the serving cell supports LP-WUS, UE may receive a LP-WUS configuration (which may be an LP-WUS activation/deactivation signaling) via RRC, including resource elements (RE), subcarrier spacing (SCS), or coding schemes such as ½ or ¼ Manchester code.

In some implementations, before UE enters an RRC idle mode, the network node may trigger a report about whether UE turns off MR. The processor of communication apparatus may report a request to turn off MR and to receive paging or system information notification only based on LP-WUS. The processor may turn off MR and only turn on and use LR to monitor LP-WUS if network node sends a confirmation to the request.

In some implementations, the request may be carried by RRC, Medium Access Control (MAC) control element (CE), or uplink control information (UCI) including whether to turn off MR and whether to enable/activate LP-WUR to monitor LP-WUS. The confirmation may be carried by RRC, MAC-CE, or downlink control information (DCI), including whether LP-WUS will be sent, or LP-WUS configurations such as UE ID, UE group ID, or monitoring sequences, start timing, duration, or frequency resources.

FIG. 12 illustrates an example scenario 1200 of LP-WUS reception ensuring procedure under schemes in accordance with implementations of the present disclosure. In some implementations, to ensure that LP-WUR is able to receive LP-WUS, network node may request a test. The processor of communication apparatus may receive a LP-WUS monitoring occasion via RRC by MR. UE may turn on both LP-WUR and MR and use LP-WUR to monitor the received monitoring occasion. If LP-WUR is able to decode LP-WUS successfully in the monitoring occasion, it sends an ACK to MR internally. MR reports the ACK to network node to confirm that LP-WUR is able to receive LP-WUS. If LP-WUR is unable to receive any LP-WUS, MR reports a NACK to the network node.

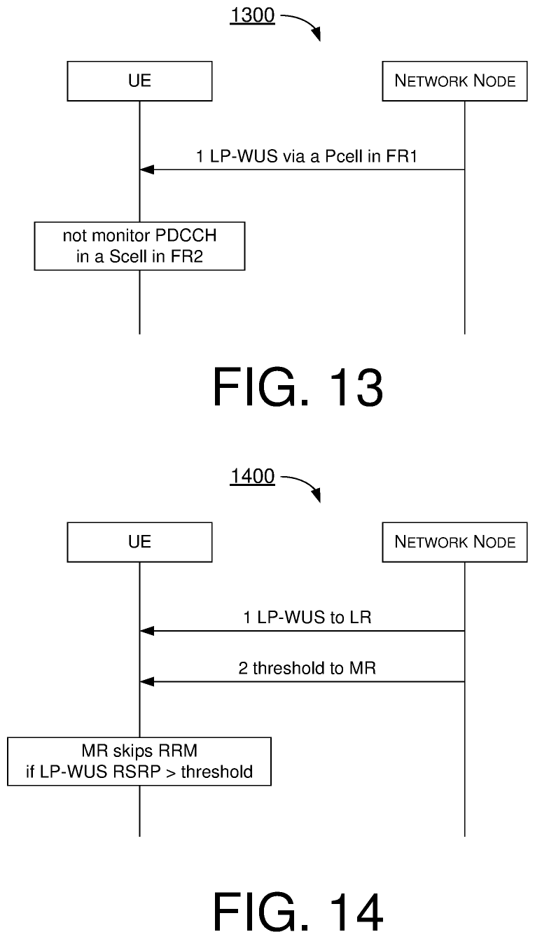

Regarding how to support frequency range (FR) 2, in some implementations, UE may be configured a primary cell (PCell) in FR1 and a second cell (SCell) in FR2. UE may receive LP-WUS in the PCell that indicates whether the SCell is in a dormancy state. If the SCell is in the dormancy state, UE may skip PDCCH monitoring or measurement in the SCell. FIG. 13 illustrates an example scenario 1300 of skipping PDCCH monitoring in SCell in FR2 under schemes in accordance with implementations of the present disclosure.

If UE receives LP-WUS in FR2, UE may monitor different LP-WUS preamble occasions configured by RRC. Each LP-WUS preamble occasion may locate in different frequency resources within an OFDM symbols or an OOK duration.

UE may monitor multiple LP-WUSs and determine one LP-WUS with the strongest received signal power. Multiple LP-WUSs with different beam directions may be multiplexed in the FDD manner. Once UE determined the strongest LP-WUS, UE only monitors the frequency occupied by the strongest LP-WUS and monitor a next preamble or a following payload. UE may assume the same beam direction is used in a frequency region/band/subcarrier set/subcarrier.

Regarding how to support LP-WUS radio resource management (RRM), in some implementations, the processor of communication apparatus may receive a plurality of LP-WUSs via the LP-WUR, combine a portion of the plurality of LP-WUSs with a predetermined property (e.g., carrying the same cell ID) to obtain a combined LP-WUS, and measure a reference signal received power (RSRP) by using the combined LP-WUS to obtain a measured RSRP. The processor may determine whether to wake up MR to perform cell reselection based on the measured RSRP.

In some implementations, the reference signal for performing RSRP measurements may also be at least one of the periodic LP-SS, the SSB, and SSS-like LP-WUS received via the LP-WUR.

In some implementations, LP-WUR may receive LP-WUS carrying cell ID. The processor of communication apparatus may combine multiple LP-WUSs only if the LP-WUSs carry the same cell ID. UE may measure RSRP by using the combined multiple LP-WUSs. UE may determine whether to wake up MR to perform cell reselection based on the measured RSRP.

In some implementations, the processor of communication apparatus may receive a periodicity of LP-WUS (e.g., the LP-WUS may have a property of time domain repetition or frequency domain repetition) and a required combination number of the LP-WUSs via RRC signaling via the transceiver. MR may report the LP-WUS based RRM measurement to network node, if requested by network node.

In another embodiment, the processor may combine multiple LP-WUSs if these LP-WUSs carry the same UE ID or UE group ID. UE may identify whether the serving cell has been changed during preamble search by using different hypothesis of preamble sequences, time domain locations, or frequency domain locations.

In some implementations, the processor of communication apparatus may report a measurement difference between SSB-based RSRP or LP-WUS based RSRP. In this case, UE may receive a threshold of LP-WUS based RSRP to wake up the MR via RRC from network node.

In some implementations, the processor of communication apparatus may report whether to support LP-WUS based RRM via RRC before entering RRC idle mode. Network node may request a LP-WUS based RRM report transmitted via MR.

In some implementations, the processor of communication apparatus may determine whether to trigger cell (re)-selection, conditional handover, 2-step random access channel (RACH), RRM relaxation, or radio link failure (RLF) report, based on the LP-WUS based RRM measurement.

FIG. 14 illustrates an example scenario 1400 of skipping or relaxing RRM measurement determination procedure under schemes in accordance with implementations of the present disclosure. In some implementations, the processor of communication apparatus may relax RRM requirement on MR if LP-WUS based measurement is above a given threshold received by MR via RRC form network node. UE may report RLF based on the LP-WUS based measurement.

In some implementations, UE may report whether a criterion for RRM relaxation for connected mode is fulfilled or not fulfilled. If the criterion for RRM measurement relaxation for connected mode is fulfilled, set the rrm-MeasRelaxation Fulfilment to true, else set the rrm-MeasRelaxationFulfilment to false. The criterion for RRM relaxation may include whether UE is not in the cell edge, e.g., LP-WUS RSRP is above a given threshold, and whether UE mobility is low, e.g., variation of LP-WUS RSRP is below a given threshold.

Regarding how to Use LP-WUS for automatic gain control (AGC), in some implementations, the processor of communication apparatus may use LP-WUS to maintain AGC. UE may receive the LP-WUS transmission power level and the SSB transmission power level in system information or RRC to determine how to control UE AGC.

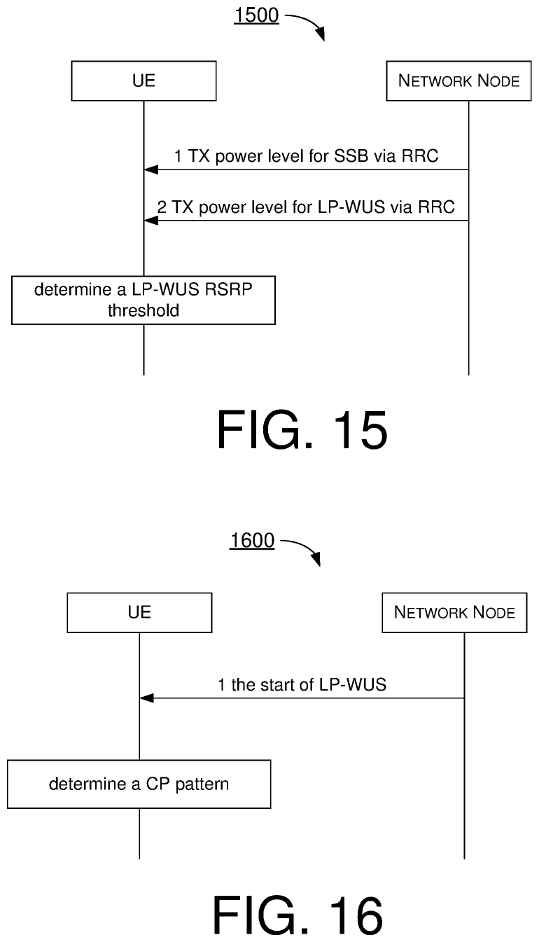

FIG. 15 illustrates an example scenario 1500 of LP-WUS RSRP threshold determination procedure under schemes in accordance with implementations of the present disclosure. In some implementations, UE may use the LP-WUS transmission power to determine a threshold for LP-WUS RSRP measurement. The threshold may be used to wake up MR or trigger other procedures mentioned above.

Regarding CP handling, in NR, CP duration is determined by 1) the SCS, 2) normal or extended CP, and 3) long symbols or remaining symbols. Each numerology has 2 long symbols per 1 ms subframe.

In some implementations, LP-WUR may not know whether LP-WUS is carried by a long OFDM symbol with a longer CP duration (>7% overhead) or normal OFDM symbols (7% overhead) within a subframe.

LP-WUR may use a part of LP-WUS within an OFDM symbol to perform preamble search. Once timing boundary is found, LP-WUR removes CP in the LP-WUS and refine its timing alignment by using the whole LP-WUS without CP.

The part may be the first part of LP-WUS preamble carrier in an OFDM symbol. UE may blind decode different CP length given a hypothesis of only two long CP values within 1 ms.

In some implementations, UE may assume LP-WUS carried by the long CP OFDM symbols has zero padding in the end of the OFDM symbol such that the CP only contain zeros.

UE may assume the start of the LP-WUS is always aligned with the slot boundary. In this case, UE may assume LP-WUS always carried by a fixed pattern starting from a long CP duration.

In some implementations, UE may assume the start of the LP-WUS is always carried by long OFDM symbols (>7% overhead). In this case, UE may assume LP-WUS always carried by a fixed pattern starting from a long CP duration.

FIG. 16 illustrates an example scenario 1600 of CP pattern determination procedure under schemes in accordance with implementations of the present disclosure. In some implementations, the processor may receive the monitoring occasions from MR, including the start of LP-WUS and SCS. In this case, UE may determine the CP pattern based on the first monitoring occasion.

In some implementations, if LP-WUR determines a CP pattern, LP-WUR may add CP on the LP-WUS preamble and remove CP on the LP-WUS data payload.

Regarding how to multiplex WUS using different SCS, in some implementations, UE may assume LP-WUS can use different SCS values than other NR data. The SCS values can be 15 kHz, 30 kHz, 60 kHz, 120 kHz, 240 KHz, 480 kHz, 960 kHz, regardless of whether the serving cell is operated in FR1 or FR2. UE may receive the SCS configurations of LP-WUS to determine the CP duration.

Regarding how to report supported frequency bands, in some implementations, LP-WUR may only support a limited number of frequency bands. UE may report the supported band via RRC to the network node and network node provides LP-WUS configurations including the operation band.

In some implementations, UE may assume the operation frequency bands for NR and LP-WUS can be the same or different. In some implementations, UE may assume the operation frequency bands for NR and LP-WUS are the same by default.

Regarding how to skip periodic WUR beacon, in some implementations, LP-WUR may receive periodic LP-WUS to maintain timing synchronization. LP-WUR may skip some of the periodic LP-WUS if one of the following criteria is met: 1) LP-WUS RSRP is above a threshold, 2) LP-WUR receives an indication that allows skipping, 3) duty cycle is configured and LP-WUR only monitor the periodic LP-WUS on duty.

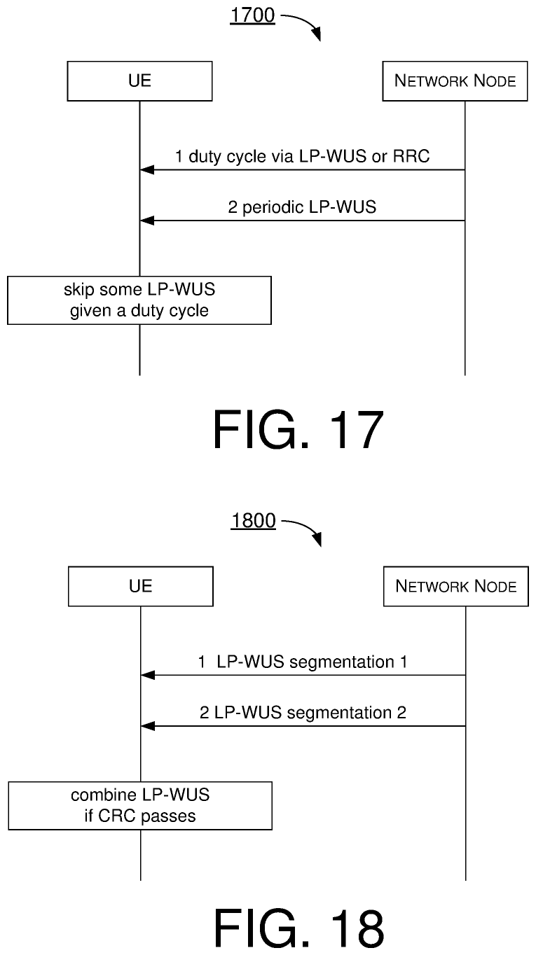

FIG. 17 illustrates an example scenario 1700 of skipping LP-WUS determination procedure under schemes in accordance with implementations of the present disclosure. In some implementations, UE may receive the configuration of the periodic LP-WUS via RRC by MR. LP-WUR may skip monitoring when MR is not turned off.

Regarding how to improve network energy savings, in some implementations, UE may receive cell discontinuous transmission (DTX) that provides NR signal muting in a serving cell. UE may only receive LP-WUS as a discovery signal to identify the cell in the cell DTX mode. UE may trigger cell wake up procedure to wake up the cell via PRACH procedure.

In some implementations, UE may contain both NR and Wi-Fi modules for Access Traffic Steering, Switching and Splitting (ATSSS). UE may receive a LP-WUS or a go-to-sleep signal from Wi-Fi module. The LP-WUS may wake up the NR module or indicate the NR module to sleep.

Regarding how to segment LP-WUS, in some implementations, the processor of communication apparatus may receive a plurality of LP-WUS segmentations via the LP-WUR, perform a cyclic redundancy check (CRC) on each LP-WUS segmentation and combine the LP-WUS segmentations based on a result of the CRC.

FIG. 18 illustrates an example scenario 1800 of LP-WUS segments combining procedure under schemes in accordance with implementations of the present disclosure. In some implementations, LP-WUR may receive LP-WUS segmentations. UE may combine the LP-WUS segmentations only if the corresponding CRC has passed. Each segmentation has its ID for UE to know whether it is allowed to combine.

In some implementations, UE may receive a segmentation timer to combine the segmentations. The timer may start when the first segmentation has been decoded. If the timer expires, UE may drop all the received segmentations, and initiate a new monitoring.

In some implementations, UE may receive segmentation retransmission or new segmentation transmission determined by a new segmentation indicator carried by LP-WUS.

In some implementations, UE may receive a new data, or a segmentation of the old data determined by a new data indicator carrier by LP-WUS.

### Illustrative Implementations

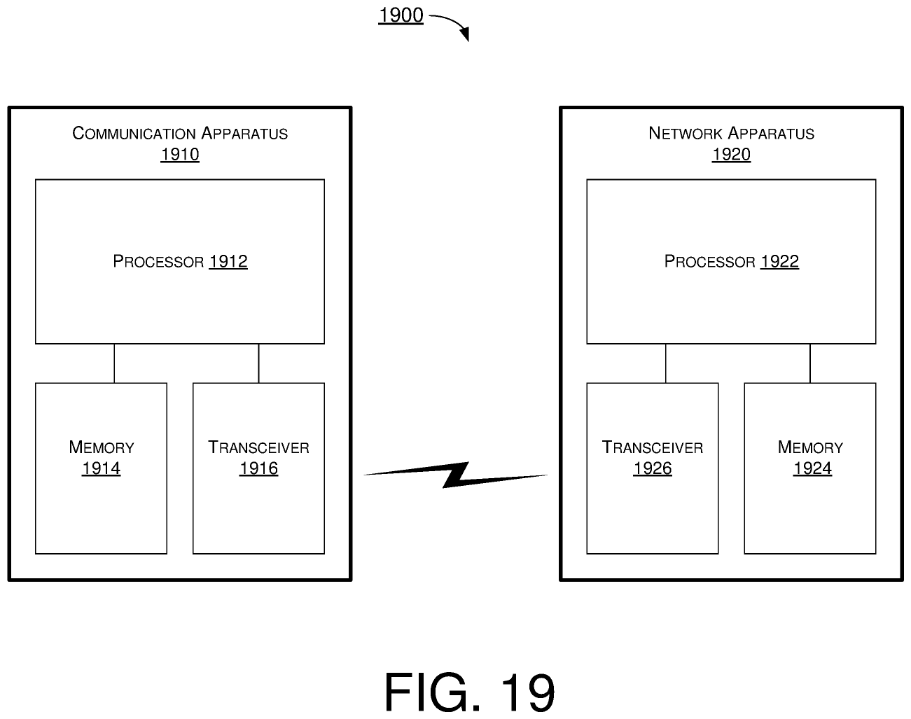

FIG. 19 illustrates an example communication system 1900 having an example communication apparatus 1910 and an example network apparatus 1920 in accordance with an implementation of the present disclosure. Each of communication apparatus 1910 and network apparatus 1920 may perform various functions to implement schemes, techniques, processes and methods described herein pertaining to network power saving with respect to user equipment and network apparatus in mobile communications, including scenarios/schemes described above as well as process 2000 described below.

Communication apparatus 1910 may be a part of an electronic apparatus, which may be a UE such as a portable or mobile apparatus, a wearable apparatus, a wireless communication apparatus or a computing apparatus. For instance, communication apparatus 1910 may be implemented in a smartphone, a smartwatch, a personal digital assistant, a digital camera, or a computing equipment such as a tablet computer, a laptop computer or a notebook computer. Communication apparatus 1910 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1910 may be implemented in a smart thermostat, a smart fridge, a smart door lock, a wireless speaker or a home control center. Alternatively, communication apparatus 1910 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1910 may include at least some of those components shown in FIG. 19 such as a processor 1912, for example. Communication apparatus 1910 may further include one or more other components not pertinent to the proposed scheme of the present disclosure (e.g., internal power supply, display device and/or user interface device), and, thus, such component(s) of communication apparatus 1910 are neither shown in FIG. 19 nor described below in the interest of simplicity and brevity.

Network apparatus 1920 may be a part of a network apparatus, which may be a network node such as a satellite, a base station, a small cell, a router or a gateway. For instance, network apparatus 1920 may be implemented in an eNodeB in an LTE network, in a gNB in a 5G/NR, IoT, NB-IoT or IIoT network or in a satellite or base station in a 6G network. Alternatively, network apparatus 1920 may be implemented in the form of one or more IC chips such as, for example and without limitation, one or more single-core processors, one or more multi-core processors, or one or more RISC or CISC processors. Network apparatus 1920 may include at least some of those components shown in FIG. 19 such as a processor 1922, for example. Network apparatus 1920 may further include one or more other components not pertinent to the proposed scheme of the present disclosure (e.g., internal power supply, display device and/or user interface device), and, thus, such component(s) of network apparatus 1920 are neither shown in FIG. 19 nor described below in the interest of simplicity and brevity.

In one aspect, each of processor 1912 and processor 1922 may be implemented in the form of one or more single-core processors, one or more multi-core processors, or one or more CISC processors. That is, even though a singular term “a processor” is used herein to refer to processor 1912 and processor 1922, each of processor 1912 and processor 1922 may include multiple processors in some implementations and a single processor in other implementations in accordance with the present disclosure. In another aspect, each of processor 1912 and processor 1922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1912 and processor 1922 is a special-purpose machine specifically designed, arranged and configured to perform specific tasks including autonomous reliability enhancements in a device (e.g., as represented by communication apparatus 1910) and a network (e.g., as represented by network apparatus 1920) in accordance with various implementations of the present disclosure.

In some implementations, communication apparatus 1910 may also include a transceiver 1916 coupled to processor 1912 and capable of wirelessly transmitting and receiving data. In some implementations, communication apparatus 1910 may further include a memory 1914 coupled to processor 1912 and capable of being accessed by processor 1912 and storing data therein. In some implementations, network apparatus 1920 may also include a transceiver 1926 coupled to processor 1922 and capable of wirelessly transmitting and receiving data. In some implementations, network apparatus 1920 may further include a memory 1924 coupled to processor 1922 and capable of being accessed by processor 1922 and storing data therein. Accordingly, communication apparatus 1910 and network apparatus 1920 may wirelessly communicate with each other via transceiver 1916 and transceiver 1926, respectively. To aid better understanding, the following description of the operations, functionalities and capabilities of each of communication apparatus 1910 and network apparatus 1920 is provided in the context of a mobile communication environment in which communication apparatus 1910 is implemented in or as a communication apparatus or a UE and network apparatus 1920 is implemented in or as a network node of a communication network.

In some implementations, transceiver 1916 may comprise a main radio (MR) and a low-power wake-up receiver (LP-WUR), as described above. In some implementations, processor 1912, which is communicatively coupled to the transceiver 1916, may receive, via LP-WUR of transceiver 1916, a periodic Low Power Synchronization Signal (LP-SS) from network apparatus 1920. Processor 1912 may perform, via LP-WUR, a synchronization based on the periodic LP-SS in an event that the MR is in a power saving mode. The synchronization may comprise at least a coarse time synchronization and a coarse frequency synchronization.

In some implementations, the periodic LP-SS comprises at least one of a primary synchronization signal (PSS) and a secondary synchronization signal (SSS).

In some implementations, processor 1912 may estimate a frequency offset based on the periodic LP-SS. Processor 1912 may perform the coarse frequency synchronization based on the estimated frequency offset.

In some implementations, processor 1912 may estimate a timing offset based on the periodic LP-SS. Processor 1912 may perform the coarse time synchronization based on the estimated timing offset.

In some implementations, processor 1912 may receive, via LP-WUR, a plurality of low-power wake-up signals (LP-WUSs). Processor 1912 may combine a portion of the plurality of LP-WUSs to obtain a combined LP-WUS. Processor 1912 may measure a reference signal received power (RSRP) by using the combined LP-WUS to obtain a measured RSRP.

In some implementations, processor 1912 may receive, via transceiver 1916, a periodicity of LP-WUS and a required combination number of the LP-WUSs via RRC signaling.

In some implementations, processor 1912 may determine whether to wake up the main radio based on the measured RSRP.

In some implementations, processor 1912 may measure RSRP by using the periodic LP-SS received via the LP-WUR.

In some implementations, processor 1912 may receive, via LP-WUR, a plurality of LP-WUS segmentations. Processor 1912 may perform a cyclic redundancy check (CRC) on each LP-WUS segmentation. Processor 1912 may combine the LP-WUS segmentations based on a result of the CRC.

In some implementations, processor 1912 may receive, via MR, a message from network apparatus 1920 via RRC signaling in an RRC connected mode. The message may be a capability enquiry message, a request message to request to turn off the main radio or a request message to request to enable the LP-WUR to assist an activation of monitoring a LP-WUS via the LP-WUR. Processor 1912 may receive, via MR, a LP-WUS configuration from network apparatus 1920. Processor 1912 may determine whether to activate the monitoring of the LP-WUS according to the message and the LP-WUS configuration.

### Illustrative Processes

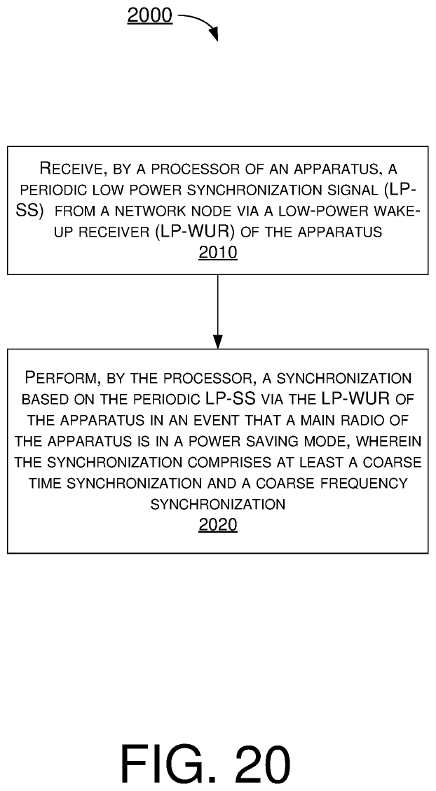

FIG. 20 illustrates an example process 2000 in accordance with an implementation of the present disclosure. Process 2000 may be an example implementation of above scenarios/schemes, whether partially or completely, with respect to network power saving with the present disclosure. Process 2000 may represent an aspect of implementation of features of communication apparatus 1910. Process 2000 may include one or more operations, actions, or functions as illustrated by one or more of blocks 2010 and 2020. Although illustrated as discrete blocks, various blocks of process 2000 may be divided into additional blocks, combined into fewer blocks, or eliminated, depending on the desired implementation. Moreover, the blocks of process 2000 may be executed in the order shown in FIG. 20 or, alternatively, in a different order. Process 2000 may be implemented by communication apparatus 1910 or any suitable UE or machine type devices. Solely for illustrative purposes and without limitation, process 2000 is described below in the context of communication apparatus 1910. Process 2000 may begin at block 2010.

At 2010, process 2000 may involve processor 1912 of communication apparatus 1910 receiving a periodic LP-SS from a network node via LP-WUR of communication apparatus 1910. Process 2000 may proceed from 2010 to 2020.

At 2020, process 2000 may involve processor 1912 performing a synchronization based on the periodic LP-SS via LP-WUR of communication apparatus 1910 in an event that MR of communication apparatus 1910 is in a power saving mode. The synchronization may comprise at least a coarse time synchronization and a coarse frequency synchronization.

In some implementations, the periodic LP-SS comprises at least one of a PSS and an SSS.

In some implementations, process 2000 may involve processor 1912 estimating a frequency offset based on the periodic LP-SS via LP-WUR. Process 2000 may involve processor 1912 performing the coarse frequency synchronization based on the estimated frequency offset via LP-WUR.

In some implementations, process 2000 may involve processor 1912 estimating a timing offset based on the periodic LP-SS via LP-WUR. Process 2000 may involve processor 1912 performing the coarse time synchronization based on the estimated timing offset via LP-WUR.

In some implementations, process 2000 may involve processor 1912 receiving a plurality of LP-WUSs via LP-WUR. Process 2000 may involve processor 1912 combining a portion of the plurality of LP-WUSs to obtain a combined LP-WUS. Process 2000 may involve processor 1912 measuring a RSRP by using the combined LP-WUS to obtain a measured RSRP.

In some implementations, process 2000 may involve processor 1912 receiving a periodicity of LP-WUS and a required combination number of the LP-WUSs via RRC signaling.

In some implementations, process 2000 may involve processor 1912 determining whether to wake up MR based on the measured RSRP.

In some implementations, process 2000 may involve processor 1912 measuring a RSRP by using the periodic LP-SS received via the LP-WUR.

In some implementations, process 2000 may involve processor 1912 receiving a plurality of LP-WUS segmentations via LP-WUR. Process 2000 may involve processor 1912 performing CRC on each LP-WUS segmentation. Process 2000 may involve processor 1912 combining the LP-WUS segmentations based on a result of the CRC.

In some implementations, process 2000 may involve processor 1912 receiving a message from network node via RRC signaling via the MR in an RRC connected mode. The message may be a capability enquiry message, a request message to request to turn off the MR or a request message to request to enable the LP-WUR to assist an activation of monitoring a LP-WUS via the LP-WUR. Process 2000 may involve processor 1912 receiving a LP-WUS configuration from network node. Process 2000 may involve processor 1912 determining whether to activate the monitoring of the LP-WUS according to the message and the LP-WUS configuration.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a periodic low power synchronization signal (LP-SS) from a network node via a low-power wake-up receiver (LP-WUR) of the apparatus; and
performing, by the processor, a synchronization based on the periodic LP-SS via the LP-WUR of the apparatus in an event that a main radio of the apparatus is in a power saving mode, wherein the synchronization comprises at least a coarse time synchronization and a coarse frequency synchronization.

2. The method of claim 1, wherein the periodic LP-SS comprises at least one of a primary synchronization signal (PSS) and a secondary synchronization signal (SSS).

3. The method of claim 1, wherein the performing of the synchronization comprises:
estimating, by the processor, a frequency offset based on the periodic LP-SS via the LP-WUR; and
performing, by the processor, the coarse frequency synchronization based on the estimated frequency offset via the LP-WUR.

4. The method of claim 1, wherein the performing of the synchronization comprises:
estimating, by the processor, a timing offset based on the periodic LP-SS via the LP-WUR; and
performing, by the processor, the coarse time synchronization based on the estimated timing offset via the LP-WUR.

5. The method of claim 1, further comprising:
receiving, by the processor, a plurality of low-power wake-up signals (LP-WUSs) via the LP-WUR;
combining, by the processor, a portion of the plurality of LP-WUSs to obtain a combined LP-WUS; and
measuring, by the processor, a reference signal received power (RSRP) by using the combined LP-WUS to obtain a measured RSRP.

6. The method of claim 5, further comprising:
receiving, by the processor, a periodicity of a low-power wake-up signal (LP-WUS) and a required combination number of the LP-WUSs via a radio resource control (RRC) signaling.

7. The method of claim 5, further comprising:
determining, by the processor, whether to wake up the main radio based on the measured RSRP.

8. The method of claim 1, further comprising:
measuring, by the processor, a reference signal received power (RSRP) by using the periodic LP-SS received via the LP-WUR.

9. The method of claim 1, further comprising:
receiving, by the processor, a plurality of low-power wake-up signal (LP-WUS) segmentations via the LP-WUR;
performing, by the processor, a cyclic redundancy check (CRC) on each LP-WUS segmentation; and
combining, by the processor, the LP-WUS segmentations based on a result of the CRC.

10. The method of claim 1, further comprising:
receiving, by the processor, a message from the network node via a radio resource control (RRC) signaling via the main radio in an RRC connected mode, wherein the message is a capability enquiry message, a request message to request to turn off the main radio or a request message to request to enable the LP-WUR to assist an activation of monitoring a low-power wake-up signal (LP-WUS) via the LP-WUR;
receiving, by the processor, a LP-WUS configuration from the network node; and
determining, by the processor, whether to activate the monitoring of the LP-WUS according to the message and the LP-WUS configuration.

11. An apparatus, comprising:
a transceiver which, during operation, wirelessly communicates with at least one network node, wherein the transceiver comprises a main radio and a low-power wake-up receiver (LP-WUR); and
a processor communicatively coupled to the transceiver such that, during operation, the processor performs operations comprising:
receiving, via the LP-WUR, a periodic low power synchronization signal (LP-SS) from the network node; and
performing, via the LP-WUR, a synchronization based on the periodic LP-SS in an event that the main radio is in a power saving mode, wherein the synchronization comprises at least a coarse time synchronization and a coarse frequency synchronization.

12. The apparatus of claim 11, wherein the periodic LP-SS comprises at least one of a primary synchronization signal (PSS) and a secondary synchronization signal (SSS).

13. The apparatus of claim 11, wherein, in performing the synchronization, the processor further performs operation comprising:
estimating a frequency offset based on the periodic LP-SS; and
performing the coarse frequency synchronization based on the estimated frequency offset.

14. The apparatus of claim 11, wherein, in performing the synchronization, the processor further performs operation comprising:
estimating a timing offset based on the periodic LP-SS; and
performing the coarse time synchronization based on the estimated timing offset.

15. The apparatus of claim 11, wherein, during operation, the processor further performs operation comprising:
receiving, via the LP-WUR, a plurality of low-power wake-up signals (LP-WUSs);
combining a portion of the plurality of LP-WUSs to obtain a combined LP-WUS; and
measuring a reference signal received power (RSRP) by using the combined LP-WUS to obtain a measured RSRP.

16. The apparatus of claim 15, wherein, during operation, the processor further performs operation comprising:
receiving, via the transceiver, a periodicity of a low-power wake-up signal (LP-WUS) and a required combination number of the LP-WUSs via a radio resource control (RRC) signaling.

17. The apparatus of claim 15, wherein, during operation, the processor further performs operation comprising:
determining whether to wake up the main radio based on the measured RSRP.

18. The apparatus of claim 11, wherein, during operation, the processor further performs operation comprising:
measuring a reference signal received power (RSRP) by using the periodic LP-SS received via the LP-WUR.

19. The apparatus of claim 11, wherein, during operation, the processor further performs operation comprising:
receiving, via the LP-WUR, a plurality of low-power wake-up signal (LP-WUS) segmentations;
performing a cyclic redundancy check (CRC) on each LP-WUS segmentation; and
combining the LP-WUS segmentations based on a result of the CRC.

20. The apparatus of claim 11, wherein, during operation, the processor further performs operation comprising:
receiving, via the main radio, a message from the network node via a radio resource control (RRC) signaling in an RRC connected mode, wherein the message is a capability enquiry message, a request message to request to turn off the main radio or a request message to request to enable the LP-WUR to assist an activation of monitoring a low-power wake-up signal (LP-WUS) via the LP-WUR;
receiving, via the main radio, a LP-WUS configuration from the network node; and
determining whether to activate the monitoring of the LP-WUS according to the message and the LP-WUS configuration.
